(19) United States
(12) Patent Application Publication
(10) Pub. No.: US 2003/0061151 A1
(43) Pub. Date: Mar. 27, 2003

(54) Method and apparatus for securing financing in a loan transaction

(76) Inventor: John Eric Hershey, Ballston Lake, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,602

(22) Filed: Sep. 26, 2001

(51) Int. Cl. G06F 17/60

(52) U.S. Cl. 705/38

(57) ABSTRACT

An apparatus and method for securing financing for a loan is provided. The apparatus and method include a loan request input module for receiving a request for the loan from a borrower. A processor is connected to the loan request input module for processing the request for the loan. A credit evaluation module is connected to the processor for determining a credit evaluation of the borrower based on the request for the loan. A loan determination module is connected to the processor and receives the credit evaluation. The loan determination module determines a first status of the loan based on predetermined criteria wherein terms of the loan are provided to the borrower when the first status has been determined. A financing solicitation module is connected to the processor for soliciting financing for the loan from investors when the first status of the loan has been determined.

### BACKGROUND OF INVENTION

The present invention relates to an apparatus and method for securing financing and managing repayment of a loan and more particularly to an apparatus and method for securing financing for a loan by soliciting financing for the loan after a borrower makes a request for the loan.

Typically, a loan organization involves a large physical plant investment, such as, for example, part of a bank. The loan organization also involves various overhead operating expenses such as, for example, a prodigious array of accounting forms, a large personnel staff, a security depository for funds and various fund transfer mechanisms. These overhead expenses associated with running such a loan organization is significant. In addition, these overhead expenses become a barrier of entry to the marketplace and a barrier to profits for any organization that is not willing to make a sizable investment. The overhead expenses of traditional loan organizations are also passed on to loan customers via the assessed interest rate. Therefore, a desire exists to reduce the overhead expenses associated with a conventional loan organization.

Further, conventional loan organizations secure funding for loans before a borrower requests a loan. The loan organizations then apportion the pre-existing fund for the requested loan based upon various loan criteria. This conventional method of financing loans requires a large amount of funds to be on hand and waiting for loan requests. As such in conventional loan organizations, the requirement of a large amount of funds being on hand and waiting for loan request is also a barrier of entry to the marketplace for any organization unable or unwilling to accumulate or commit such funds. Thus, a desire exists to lower overhead expenses and minimize the barriers of entry to the marketplace. Further, a desire exists to minimize the amount of funds required to be on hand and waiting for a request for a loan.

### SUMMARY OF INVENTION

In one exemplary embodiment, a system and method for securing financing of a loan comprises a low overhead, small fixed plant, small workforce, money raising and lending operation. The system and method for securing financing is based on modern high-subscriber presence instruments such as the Internet. The system and method for securing financing has an inherently high flexibility for setting interest rates and profit levels. The system and method for securing financing also allows the public to underwrite and finance loans by contributing small amounts of cash and credit to the system for securing financing, and the proffered cash and credit investments are accumulated until the requested loan amount has been amassed. The system for securing financing also disburses the loan to the borrower who is seeking the loan. The system for securing financing also receives the loan payments and disburses a portion thereof to the investors and/or financing entities. An entity operating the system for securing financing may realize a profit by one or more of the following mechanisms in consonance with applicable Federal and state laws and sanctioned banking and accounting practices. In one embodiment, the entity operating the system for securing financing may charge the borrower an up-front fee for service. In another embodiment, the entity operating the system for securing financing may assess a fee levied on the interest generated by the loan. In even another embodiment, the entity operating the system for securing financing may derive interest on the funds accumulated during the loan amassment period rather than placing the funds in an escrow account.

### BRIEF DESCRIPTION OF DRAWINGS

FIG. 1 is a block diagram view of one representative embodiment of a system for securing financing.

FIG. 2 is a networking view of another representative embodiment of a system for securing financing.

FIG. 3 is a schematic view of even another representative embodiment of a system for securing financing.

FIG. 4 is a flow diagram view of one representative embodiment of a method for securing financing and managing repayment of a loan.

### DETAILED DESCRIPTION

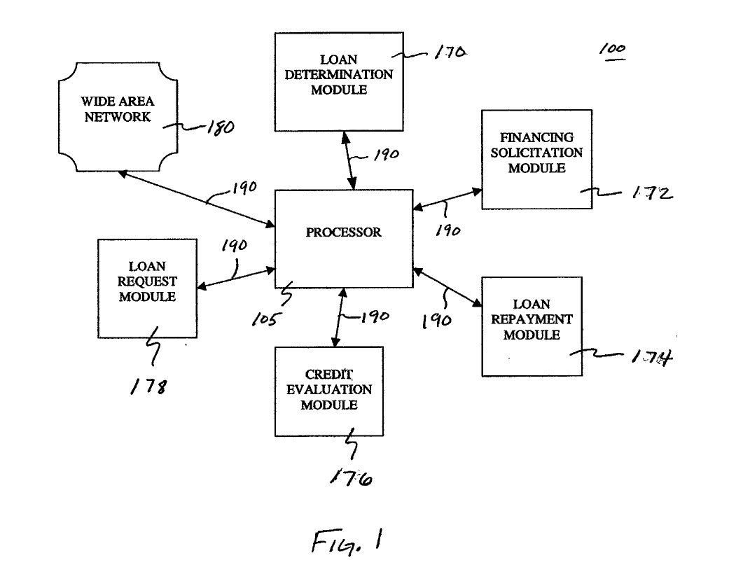

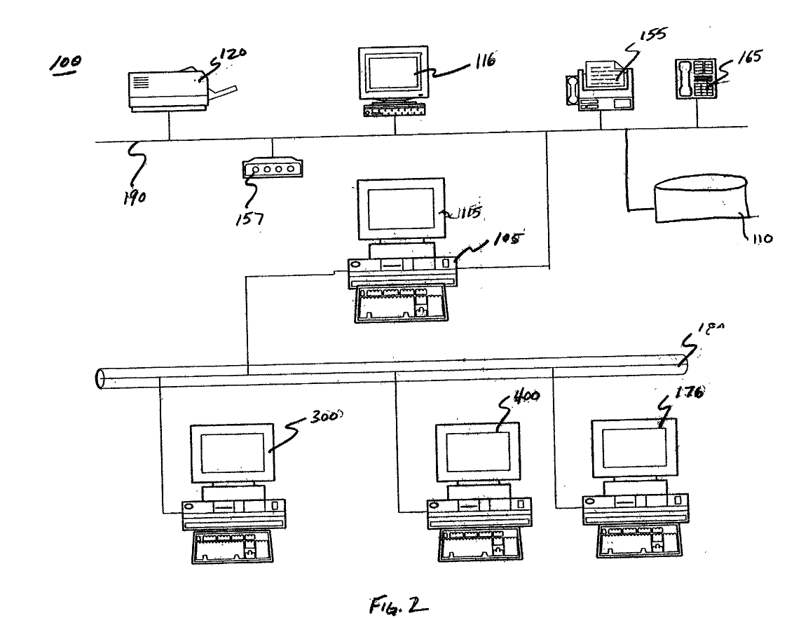

In FIG. 1, one embodiment of a system for securing financing 100 comprises a processor 105 that is connected via an electronic channel 190 to a loan request module 178 that receives a request for a loan from a borrower 300 (FIG. 2). The processor 105 is connected via an electronic channel 190 to a credit evaluation module 176 that evaluates the credit rating of the borrower. A loan determination module 170 is connected to the processor 105 via an electronic channel 190 and makes a determination as to whether a loan should be offered to the borrower based upon, for example, the credit rating of the borrower. In addition, the loan determination module 170 also proposes terms of the loan to the borrower when financing has been approved. The processor 105 is also connected to a financing solicitation module 172 via an electronic channel 190. The financing solicitation module 172 solicits financing to secure and/or obtain funds for the accepted loan from a financing entity 400 (FIG. 2). In one embodiment, the financing entity 400 (FIG. 2) can also be termed investor. Also, a loan repayment module 174 is connected via the electronic channel 190 to the processor 105. Once the financing solicitation module 172 has secured financing for the loan, the loan repayment module 174 manages repayment of the loan by the borrower 300 (FIG. 2). In one embodiment, the processor 105 is also connected to a wide area network 180 via an electronic channel 190. Also, in another embodiment, at least one of the loan request module 178, loan determination module 170, the financing solicitation module 172, the loan repayment module 174 and the credit evaluation module 176 comprise a computer program or software that can be executed by the processor 105 or other systems to perform specifically designed tasks. It should also be appreciated that the borrower 300 can comprise, an individual, corporation or other entity that is seeking a loan. Further, it should also be appreciated that the financing entity 400 (FIG. 2) can comprise an individual, a company, a corporation, a bank or other entity that has the ability to supply the entire amount or a portion of the financing for the loan. In addition, it should also be appreciated that the financing entity 400 may comprise a combination of various entities, such as, individuals, corporations, companies, banks or other entities, that each provide a portion of the financing for the entire loan amount. Also, it should be appreciated that, in another embodiment, the financing entity 400 can comprise, a single individual, company, corporation, bank or other entity, that provides financing for the entire amount of the loan.

In another embodiment, as shown in FIG. 2, the system for securing financing 100 includes a processor 105 that comprises, such as, for example, a personal computer, a workstation, a mini-computer, a mainframe computer or a supercomputer. The processor 105 is connected to an electronic channel 190 that comprises, such as, for example, a telephone or cable network, an ethernet, a local area network (LAN), or a wide area network (WAN) 180, an integrated services digital network (ISDN), or a digital subscriber line (DSL). In addition, the electronic channel 190 is connected to various other electronic systems, such as, for example, external memory/storage 110, printers 120, other computing devices 116, facsimile machines 155 or telephone headsets 165. It should be appreciated that other devices, such as, for example, plotters, synthesizers and speakers, may also be connected to the electronic channel 190. It should further be appreciated that the external memory/storage 110 can comprise, such as, for example all types of disk drives such as floppy disks, hard disks and optical disks, as well as tape drives that can read and write data onto a tape that could include digital audio tapes (DAT), digital linear tapes (DLT), or other magnetically coded media.

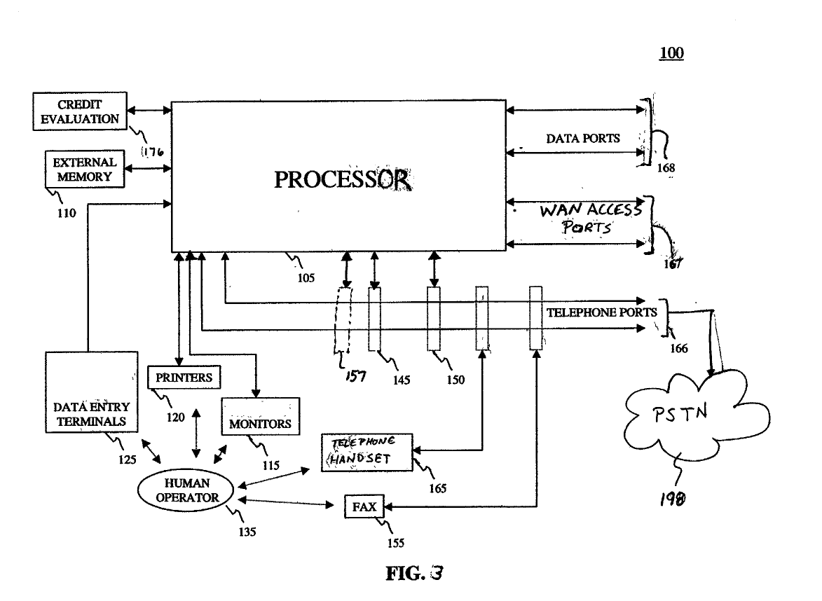

As further shown in FIG. 2, the processor 105 having monitor 115 is connected to a wide area network (WAN) 180. In one embodiment, the wide area network (WAN) 180 enables the processor 105 to access or be accessed by other processors, computers and resources on a network such as, for example, a private network such as an extranet or intranet or a global network such as the Internet. In addition, as shown in the embodiment of FIG. 2, the processor 105 connects via the wide area network (WAN) 180 to other computers that are operated by, for example, the borrower 300, the financing entity 400 and the credit evaluation module 176. It should be appreciated that, in other embodiments, the loan request module 178, the loan determination module 170, the financing solicitation module 172 and the loan repayment module 174 can also be implemented via other computers connected to the wide area network (WAN) 180. Further, in another embodiment, the electronic channel 190 can also comprise the wide area network (WAN) 180, and, as such, two separate network connections to the processor 105, as shown, in FIG. 2, would not be used. In even another embodiment, the electronic channel 190 is connected to a public switched telephone network (PSTN) 198 (FIG. 3). It should be appreciated that the public switched telephone network (PSTN) 198 (FIG. 3) can also comprise a dual tone multi-frequency telephone network (not shown).

In yet another embodiment, the system for securing financing 100 comprises the processor 105. In this embodiment, the processor 105 can comprise, such as, for example, a microprocessor, an arithmetic logic unit (ALU) or an electronic computer. An external memory/storage 110 is connected to the processor 105, and using the external memory/storage 110, the processor 105 can store and retrieve data or other information. It should be appreciated that, in one embodiment, the external memory/storage 110 can comprise, such as, for example, a random-access memory (RAM) and a read-only memory (ROM) or other types of memory such as programmable read-only memory (PROM), erasable programmable read-only memory (EPROM) and electrically erasable programmable read-only memory (EEPROM). It should also be appreciated that, in another embodiment, the external memory/storage 110 can comprise, such as, for example, all types of disk drives such as floppy disks, hard disks and optical disks, as well as tape drives that can read and write data onto a tape that could include digital audio tapes (DAT), digital linear tapes (DLT), or other magnetically coded media.

As shown in FIG. 3, the processor 105 connects external data ports 168 that are used to electronically interconnect to specialized networks, such as, for example, the electronic channel 190 (FIG. 2), an ethernet, a local area network (LAN) or other network or peripheral components/equipment. Wide area network (WAN) access ports 167 are also connected to the processor 105 and connect the processor 105 to a wide area network (WAN), such as, for example, the Internet. Also, telephone ports 166 are connected to the processor 105. In one embodiment, the telephone ports 166 are also connected to a facsimile machine 155, a telephone handset 165, a speech recognition system 145, a voice synthesizer unit 150 and a modem 157. In one embodiment, a speech recognition system 145 and a voice synthesizer unit 150 allow a borrower 300, a financing entity 400 or any of the modules 170, 172, 174, 176 and 178 to communicate with the processor 105 via telephone where the voice synthesizer unit 150 generates a facsimile of speech guiding, for example, the borrower 300 to prepare the loan request from the loan request module 178 and the speech recognition system 145 interprets audio responses generated by the borrower 300. Further, in another embodiment, the modem 157 connected to the telephone ports 166 and the processor 105 also allow a borrower 300, a financing entity 400 or any of the modules 170, 172, 174, 176 and 178 to communicate directly to the processor 105 via a computing device, such as, for example, a computer. The telephone ports 166 also connect to the telephone handset 165 and facsimile machine 155 such that a human operator 135 can communicate via these devices with a borrower 300, a financing entity 400 or any of the modules 170, 172, 174, 176 and 178. Further, the telephone ports 166 are connected to a public switched telephone network (PSTN) 198. Also shown in FIG. 3, the human operator 135 can operate or interact with monitors 115, data entry terminals 125 and printers 120 that are also connected to the processor 105. In one embodiment, a human operator 135 can, for example, receive the request for a loan from the borrower 300, obtain the credit evaluation, evaluate the credit rating, determine the loan criteria and obtain/secure financing for the loan from all the devices set out above. In another embodiment, the speech recognition system 145 interprets responses entered by the borrower 300 through a key pad connected to a telephone handset 165. In addition, other devices, such as, for example, external memory/storage 110 can be directly connected to the processor 105. Also, the credit evaluation module 176 can also be directly connected to the processor 105. It should be appreciated that, in other embodiments, other modules 170, 172, 174, 176 and 178 can also be directly connected to the processor 105.

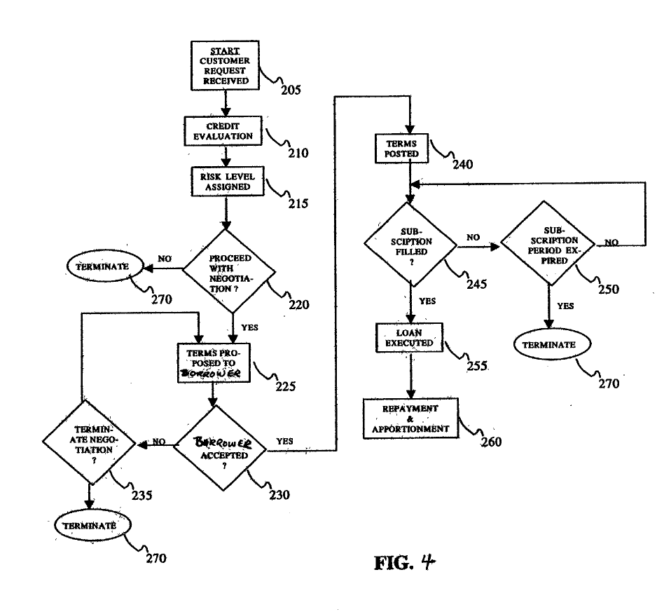

Also shown in FIG. 4, one embodiment of a method for securing financing for a loan 200 includes receiving a request for a loan from a borrower 300 (step 205). In the request for the loan (step 200), the borrower 300 can provide information, such as, for example, name, address, social security number, birth date, income, employment history and/or other information. In one embodiment, when requesting the loan, the borrower 300 can use the loan request module 178 (FIG. 1). In another embodiment, the borrower 300 can request the loan by contacting the processor 105 via a telephone port 166 using the speech recognition system 145, the voice synthesizer unit 157, the facsimile machine 155 and/or the modem 150. In even another embodiment, the borrower 300 can request a loan using a telephone port 166 and communicating with a human operator 135 via a telephone handset 165. When the request for a loan has been received, the credit rating of the borrower 300 is obtained and evaluated (step 210). In one embodiment, the credit rating can be obtained by using the credit evaluation module 176 (FIG. 1). In another embodiment, the credit rating comprises a credit report and/or rating from a credit reporting agency. After the credit rating has been obtained and evaluated, a risk level is assigned to the borrower (step 215). In another embodiment, the risk level is based, in part, upon an evaluation of the credit rating and/or report and information provided by the borrower 300 in the request for the loan using predetermined criteria. After the risk level has been determined, a decision is made whether to accept the loan request based upon the risk level and proceed with a negotiation of terms of the loan (step 220). In one embodiment, the decision to accept the loan request can be performed by the loan determination module 170. In another embodiment, the decision may be made according to pre-stored risk tables, and, also, the decision may involve the human operator 135 (FIG. 3). If the decision is made not to accept the loan, the loan process is terminated (step 270). If the decision is made to accept the loan and proceed with negotiating terms of the loan, the terms of the loan are proposed to the borrower 300 (step 225). It should be appreciated that the terms of the loan can comprise the amount borrowed, the length of repayment, the interest rate, other associated fees and other loan terms. In one embodiment, the terms of the loan can be from a predetermined loan agreement and/or loan repayment schedule, or the loan agreement and/or loan repayment schedule can be prepared by a human operator 135 (FIG. 3). After the terms of the loan have been presented, a determination is made whether the borrower 300 accepts the terms of the loan (step 230). If the borrower 300 does not accept the loan terms, the loan terms can be negotiated (step 235) and new terms can be presented to the borrower 300 (step 225). If negotiated terms are not acceptable to all parties involved, the loan request can be terminated (step 270). When the borrower 300 has accepted the terms of the loan, the terms are posted (step 240) such that a financing entity 400 can view the terms of the loan to determine if the financing entity 400 should provide funding for the loan. In one embodiment, the financing solicitation module 172 (FIG. 1) posts the terms of the loan. Further, in another embodiment, the terms of the loan can be posted on the wide area network (WAN), such as, for example, the Internet.

When the terms of the loan have been posted, the loan is assigned a time period to solicit public subscriptions. The time period to solicit pubic subscriptions is presented as a term in the loan agreement presented to the borrower 300. In one embodiment, the solicitation of public subscriptions comprises soliciting financing from financing entities 400. In this embodiment, each subscription can have a predetermined monetary amount, and the financing entity 400 can fill and/or purchase all or any number of subscriptions. The financing solicitation module 172 can, in one embodiment, perform the solicitation of public subscriptions. In another embodiment, the solicitation of public subscriptions can be performed by posting subscription information on the wide area network, such as, the Internet. Further, when the financing entity 400 fills or purchases a subscription, the financing entity 400 also agrees to terms of a subscription agreement. Once the public subscriptions are solicited, a determination is periodically made whether the total amount of subscriptions has been filled (step 245). In one embodiment, filling the total amount of subscriptions can comprise obtaining funding/financing for the full amount of the loan by, for example, filling or purchasing all or a remainder of the subscription that are available. The determination of whether the total amount subscriptions has been filled can be made on a predetermined time basis, or the determination can be made whenever a subscription is filled and/or purchased. If the subscription has not been filled, a determination is made as to whether the subscription period has expired (step 250). If the subscription period has ended without filling or purchasing the entire amount of subscriptions, the loan subscription and/or the loan agreement is terminated (step 270). Further, any public subscriptions that have been purchased and and/or funds that have been transferred are returned to the financing entity 400 according to subscription terms. In one embodiment, the loan may be re-posted for subscriptions after the first subscription period. If the subscription period has not ended, the terms continue to be posted until the subscriptions are filled or until the subscription period ends. If all of the public subscriptions are filled within the subscription period, the loan is executed (step 255). In one embodiment, a certification of acceptance of terms by the borrower 300 is completed. In another embodiment, the borrower 300 completes the certificate of acceptance via an electronic signature method over the wide area network (WAN), such as, for example, the Internet. Once the borrower 300 has completed the certificate of acceptance, the loan then passes to repayment and apportionment (step 260). In one embodiment, the loan repayment module 174 (FIG. 1) performs the repayment and apportionment of the loan. During repayment and apportionment, loan payments are collected from the borrower 300. Further, in one embodiment, the loan payment is certified, and distributed to the financing entities 400 that purchased public subscriptions. In addition, the entity that is running the system for securing financing 100 (FIG. 1) also collects a fee for service from the repayment of the loan by borrower 300. Such a fee collected by the entity running the system for securing financing 100 is presented as terms in the loan agreement with the borrower 300 and subscription agreement with the financing entity 400.

The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

1. An apparatus for securing financing and managing repayment of a loan, the apparatus comprising:
a loan request input module for receiving a request for the loan from a borrower;
a processor connected to the loan request input module for processing the request for the loan;
a credit evaluation module connected to the processor for determining a credit evaluation of the borrower based on the request for the loan;
a loan determination module connected to the processor and receiving at least the credit evaluation, the loan determination module determining at least a first status of the loan based on predetermined criteria wherein terms of the loan are provided to the borrower when the first status has been determined;
a financing solicitation module connected to the processor for soliciting financing for the loan from investors when the first status of the loan has been determined; and
a repayment module connected to the processor for servicing and managing repayment of the loan by the borrower.

2. The apparatus of claim 1 wherein the loan request input module comprises an electronic channel connected to a wide area network (WAN).

3. The apparatus of claim 2 wherein the wide area network (WAN) comprises the Internet.

4. The apparatus of claim 1 wherein the loan request input module comprises an electronic channel connected to a public switched telephone network.

5. The apparatus of claim 1 wherein the loan request input module comprises an electronic channel connected to a facsimile machine, wherein the facsimile machine is connected to a public switched telephone network.

6. The apparatus of claim 1 wherein the loan request input module comprises an electronic channel connected to a voice synthesizer unit and a speech recognition system.

7. The apparatus of claim 1 wherein the loan request input module comprises an electronic channel connected to a dual tone multi-frequency telephone network.

8. The apparatus of claim 1 wherein the credit evaluation module is connected to the processor via a wide area network (WAN).

9. The apparatus of claim 8 wherein the wide area network (WAN) is connected to the Internet.

10. The apparatus of claim 1 wherein the credit evaluation module is connected to the processor via an electronic channel connected to a public switched telephone network.

11. The apparatus of claim 1 wherein the processor is connected to at least one monitor.

12. The apparatus of claim 1 wherein the processor is connected to at least one printer.

13. The apparatus of claim 1 wherein the processor further comprises at least one data entry terminal.

14. The apparatus of claim 1 wherein the financing solicitation module comprises an electronic channel connected to a wide area network (WAN).

15. The apparatus of claim 14 wherein the wide area network comprises the Internet.

16. The apparatus of claim 1 wherein the repayment module comprises an electronic channel connected to a wide area network (WAN).

17. The apparatus of claim 16 wherein the wide area network comprises the Internet.

18. The apparatus of claim 1 wherein the processor is connected to a wide area network (WAN).

19. The apparatus of claim 18 wherein the wide area network (WAN) comprises the Internet.

20. An apparatus for securing financing for a loan, the apparatus comprising:
a loan request input module for receiving a request for the loan from a borrower;
a processor connected to the loan request input module for processing the request for the loan;
a credit evaluation module connected to the processor for determining a credit evaluation of the borrower based on the request for the loan;
a loan determination module connected to the processor and receiving at least the credit evaluation, the loan determination module determining at least a first status of the loan based on predetermined criteria wherein terms of the loan are provided to the borrower when the first status has been determined; and
a financing solicitation module connected to the processor for soliciting financing for the loan from investors when the first status of the loan has been determined.

21. The apparatus of claim 20 further comprising a repayment module connected to the processor for servicing and managing repayment of the loan by the borrower.

22. The apparatus of claim 21 wherein the processor is connected to a wide area network (WAN).

23. The apparatus of claim 22 wherein the wide area network (WAN) comprises the Internet.

24. A method for securing financing and managing repayment of a loan, the method comprising the steps of:
receiving a request for a loan from a borrower;
obtaining a credit evaluation of the borrower;
assigning a risk level for the loan based on at least the credit evaluation of the borrower;
providing terms of the loan to the borrower when the risk level for the loan meets predetermined criteria;
soliciting financing for the loan based on at least the terms of the loan and the risk level assigned to the loan when the risk level meets at least the predetermined criteria;
executing the loan; and
managing repayment of the loan.

25. The method of claim 24 wherein the step of receiving the request for the loan comprises receiving the request for the loan using an electronic channel connected to a wide area network (WAN).

26. The method of claim 25 wherein the wide area network comprises the Internet.

27. The method of claim 24 wherein the step of receiving the request for the loan comprises receiving the request of the loan using an electronic channel connected to a public switched telephone network.

28. The method of claim 24 wherein the step of receiving the request for the loan comprises receiving the request for the loan using an electronic channel connected to a facsimile machine and wherein the facsimile machine is connected to a public switched telephone network.

29. The method of claim 24 wherein the step of receiving the request for the loan comprises receiving the request for the loan using an electronic channel connected to a voice synthesizer unit and a speech recognition system.

30. The method of claim 24 wherein the step of receiving the request for the loan comprises receiving the request for the loan using an electronic channel connected to a dual tone multi-frequency telephone network.

31. The method of claim 24 wherein the step of obtaining the credit evaluation of the borrower comprises obtaining the credit evaluation of the borrower using a credit evaluation module.

32. The method of claim 24 wherein the step of obtaining the credit evaluation of the borrower comprises obtaining the credit evaluation using an electronic channel connected to a wide area network (WAN).

33. The method of claim 32 wherein the wide area network (WAN) comprises the Internet.

34. The method of claim 24 wherein the step of obtaining the credit evaluation of the borrower comprises obtaining the credit evaluation using an electronic channel connected to a public switched telephone network.

35. The method of claim 24 wherein the step of obtaining the credit evaluation of the borrower comprises obtaining the credit evaluation using an electronic channel connected to a facsimile machine and wherein the facsimile machine is connected to a public switched telephone network.

36. The method of claim 24 wherein the step of assigning the risk level to the borrower comprises determining the risk level according to at least one pre-stored risk table.

37. The method of claim 24 wherein the step of assigning the risk level to the borrower comprises determining the risk level according to predetermined criteria.

38. The method of claim 24 wherein the step of providing the terms of the loan to the borrower comprises determining the terms of the loan according to at least one pre-stored loan repayment schedule.

39. The method of claim 24 wherein the step of providing the terms of the loan to the borrower comprises determining the terms of the loan according to predetermined criteria.

40. The method of claim 24 wherein the step of proposing the terms of the loan to the borrower comprises proposing the terms of the loan using an electronic channel connected to a wide area network (WAN).

41. The method of claim 40 wherein the wide area network (WAN) comprises the Internet.

42. The method of claim 24 wherein the step of executing the loan comprises executing the loan using an electronic signature of the borrower.

43. The method of claim 24 wherein the step of managing repayment of the loan comprises managing repayment of the loan using an electronic channel connected to a wide area network (WAN).

44. The method of claim 43 wherein the wide area network (WAN) comprises the Internet.

45. A method for securing financing for a loan, the method comprising the steps of:
receiving a request for a loan from a borrower via a wide area network (WAN);
obtaining a credit evaluation of the borrower from the wide area network (WAN);
assigning a risk level for the loan based on at least the credit evaluation of the borrower;
providing terms of the loan to the borrower when the risk level for the loan meets predetermined criteria via the wide area network (WAN);
soliciting financing for the loan via the wide area network (WAN) based on at least the terms of the loan and the risk level assigned to the loan when the risk level meets at least the predetermined criteria; and
executing the loan via the wide area network (WAN).

46. The method of claim 45 wherein the wide area network (WAN) comprises the Internet.

47. The method of claim 45 further comprising the step of managing repayment of the loan via the wide area network (WAN).

48. The method of claim 47 wherein the wide area network (WAN) comprises the Internet.
